(19) United States
(12) Patent Application Publication
(10) Pub. No.: US 2009/0168085 A1
(43) Pub. Date: Jul. 2, 2009

(54) IMAGE PROCESSING METHOD AND IMAGE PROCESSING APPARATUS

(75) Inventor: Shintarou Suzuki, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/326,829

(22) Filed: Dec. 2, 2008

(30) Foreign Application Priority Data
Dec. 27, 2007 (JP) 2007-337661

(51) Int. Cl. H04N 1/00

(52) U.S. Cl. 358/1.9

(57) ABSTRACT

Image processing for creating bitmap data based on a plurality of drawing objects by sequentially rendering the plurality of drawing objects respectively having drawing attributes and drawing logic, and sequentially updating the bitmap data and attribute information for each pixel of the bitmap data, has the following characteristic feature. That is, a transparent object group, which expresses transparent processing and includes a plurality of drawing objects, is detected based on the drawing logic, and the drawing attribute of a predetermined drawing object in the detected transparent object group is updated to an attribute indicating that the attribute information is not updated. For example, for transparent processing including three continuous drawing objects having drawing logic “EXOR”, “overwrite”, and “EXOR”, the first and last drawing objects of the EXOR are controlled not to update attribute information for each pixel upon drawing, thus obtaining appropriate attribute information.

### BACKGROUND OF THE INVENTION

1. Field of the Invention

The present invention relates to an image processing method and image processing apparatus, which create attribute information corresponding to input drawing objects upon rendering the drawing objects to a bitmap.

2. Description of the Related Art

In general, an image output device such as a printer or the like, which allows a high-quality image output, receives drawing commands from a host computer side via a driver, and renders a multi-valued bitmap of a total of 24 bits of RGB data on an internal multi-valued bitmap area of the device. Upon completion of processing of all the drawing commands, the device applies color processing (color correction, color conversion, n-ary processing, and the like) to the entire multi-valued bitmap area to convert the bitmap data into that on a device-dependent color space.

However, the rendered multi-valued bitmap data does not particularly hold its attribute information. For this reason, it is difficult for an arbitrary pixel to determine a drawing object (e.g., graphic, text, image, or the like) to be drawn, and to apply optimal color processing to that pixel.

Hence, as a method of applying optimal color processing to each arbitrary pixel, a method of providing attribute information to all pixels is known. For example, as a simple method, a method of further reserving 8 bits for attribute information in correspondence with one pixel configured by a total of 24 bits of RGB data, and processing one pixel as a total of 32 bits of RGB+A data is known. Alternatively, in another method, one pixel remains configured by 24 bits of RGB data, and an attribute information memory (to be referred to as an attribute information storage area hereinafter) is allocated on an independent area. FIG. 3 shows the concept of color processing using such attribute information storage area.

Referring to FIG. 3, PDL data is interpreted to create a drawing object. Upon rendering the drawing object, RGB raster image data and attribute information are created. Upon execution of color conversion processing for each pixel, appropriate processing is assigned to each pixel with reference to attribute information corresponding to that pixel. For example, when an attribute is “graphic”, the control is made to apply color conversion processing suited to “graphic”. When an attribute is “image”, the control is made to apply color conversion processing suited to “image”. This makes it possible to perform appropriate color conversion processing for all pixels. According to this method, every time a pixel in the multi-valued bitmap area is updated, the attribute information storage area that stores attribute information corresponding to that pixel is updated.

As a method of determining attribute information by allocating the attribute information storage area, a method that particularly considers overlap of objects is known. With this method, an object to be drawn on a top face is determined based on the overlap of objects before drawing, and the drawing attribute of the object on the top face is written in the attribute information storage area for respective pixels (for example, Japanese Patent Laid-Open No. 2002-297121, referred to herein as “JPA 2002-297121”).

As described above, according to the method that considers the object on the top face, optimal processing can be done when a drawing object to be drawn on the top face is determined for respective pixels before drawing, like a renderer, the drawing algorithm of which is based on a scan-line model.

However, a renderer, the drawing algorithm of which is based on a painters model, draws drawing objects sent to itself in the order they are sent. That is, the renderer based on the painters model does not determine a drawing object to be drawn on the top face for respective pixels before drawing unlike the renderer based on the scan-line model. Therefore, in this case, the attribute information storage area is updated by overwriting for respective drawing objects in the order these objects are sent to the renderer. For this reason, when transparent processing to be designated between a plurality of drawing objects and a background is executed, the following problems may be posed.

For example, a case will be examined below wherein regions which respectively have “none”, “image”, and “graphic” as drawing attributes of objects are overlaid on a background as a destination, as shown in FIG. 4. In this case, the contents of an attribute information storage area 401 created in practice based on the painters model are often different from those of an ideally updated attribute information storage area 402. In FIG. 4, a difference is generated particularly for a region 403, that is, the contents of the attribute information storage area cannot be normally updated in association with the region 403.

In this way, upon overlapping drawing objects based on the painters model, since attribute information of each object is not ideally updated, appropriate color processing cannot be applied to each individual attribute.

A cause of occurrence of such problem will be described in more detail below with reference to FIGS. 5A and 5B.

FIGS. 5A and 5B show a state in which a drawing object 502 having an EXOR drawing logic, a black drawing object 503 having an overwrite (or transparent) drawing logic, and a drawing object 504 having an EXOR drawing logic are overlaid and drawn in turn on a background 501. Note that the drawing objects 502 and 504 are identical objects. For the sake of simplicity, the drawing objects 502, 503, and 504 will be respectively referred to as first, second, and third drawing objects hereinafter.

In FIGS. 5A and 5B, as shown in the upper stage of FIG. 5A, the first drawing object 502 is overlaid on the background 501, all pixels of which have a drawing attribute “image”, by performing EXOR. At this time, a drawing attribute (graphic) of the first object 502 is overwritten on an attribute information storage area 510. As a result, as shown in the lower stage of FIG. 5A, regions 502a and 502b of the background 501 and attribute information storage area 510 are updated in correspondence with the first drawing object 502.

Next, the black second drawing object 503 is overlaid by overwriting. As shown in the upper stage of FIG. 5B, regions 503a and 503b of the background 501 and attribute information storage area 510 are updated by overwriting in correspondence with the second drawing object 503.

Finally, the third drawing object 504 is overlaid by performing EXOR. In this way, the first to third drawing objects are drawn in turn. As a result, as shown in the lower stage of FIG. 5B, a drawing result 505 equivalent to processing for setting the first drawing object 502 (or third drawing object 504) to be transparent in the shape of the second drawing object 503 can be obtained as a final drawing result. However, as for the attribute information storage area 510, since a drawing region 504b of the third drawing object 504 is finally overwritten on the shape of the second drawing object 503, the attribute information is not normally updated.

Furthermore, since the aforementioned sequence of the transparent processing cannot be determined from each of the first to third objects 502 to 504 before drawing, the method described in JPA 2002-297121 cannot be applied to the transparent processing.

### SUMMARY OF THE INVENTION

The present invention has been made to solve the aforementioned problems, and provides an image processing method and image processing apparatus. The image processing method and image processing apparatus implement the function of, upon updating bitmap data by sequentially rendering a plurality of drawing objects, which express transparent processing, appropriately update attribute information for each pixel of the bitmap data.

According to an aspect of the present invention, an image processing method of creating bitmap data based on a plurality of drawing objects by sequentially rendering the plurality of drawing objects respectively having drawing attributes and drawing logic, and sequentially updating the bitmap data and attribute information for each pixel of the bitmap data, includes: detecting a transparent object group, which expresses transparent processing and includes a plurality of drawing objects, based on the drawing logic; and updating a drawing attribute of a predetermined drawing object of the plurality of drawing objects in the detected transparent object group to an attribute indicating that the attribute information of the bitmap data is not updated.

According another aspect of the present invention, an image processing method of creating bitmap data based on a plurality of drawing objects by sequentially rendering the plurality of drawing objects respectively having drawing attributes and drawing logic, and sequentially updating the bitmap data and attribute information for each pixel of the bitmap data includes: detecting a transparent object group, which expresses transparent processing and includes a plurality of drawing objects, based on the drawing logic; and generating a composite object by composing the drawing objects which configure the detected transparent object group in correspondence with the drawing logic, wherein the composite object is used in place of the transparent object group upon drawing.

According to another aspect of the present invention, an image processing apparatus for creating bitmap data based on a plurality of drawing objects by sequentially rendering the plurality of drawing objects respectively having drawing attributes and drawing logic, and sequentially updating the bitmap data and attribute information for each pixel of the bitmap data includes: a detection unit adapted to detect a transparent object group, which expresses transparent processing and includes a plurality of drawing objects, based on the drawing logic; and an updating unit adapted to update a drawing attribute of a predetermined drawing object of the plurality of drawing objects in the detected transparent object group to an attribute indicating that the attribute information of the bitmap data is not updated.

According to yet another aspect of the present invention, an image processing apparatus for creating bitmap data based on a plurality of drawing objects by sequentially rendering the plurality of drawing objects respectively having drawing attributes and drawing logic, and sequentially updating the bitmap data and attribute information for each pixel of the bitmap data includes: a detection unit adapted to detect a transparent object group, which expresses transparent processing and includes a plurality of drawing objects, based on the drawing logic; and composing unit adapted to generate a composite object by composing the drawing objects which configure the detected transparent object group in correspondence with the drawing logic, wherein the composite object is used in place of the transparent object group upon drawing.

According to the present invention with the above arrangement, upon updating bitmap data by sequentially rendering a plurality of drawing objects, which express transparent processing, attribute information for each pixel of the bitmap data can be appropriately updated.

Further features of the present invention will become apparent from the following description of exemplary embodiments with reference to the attached drawings.

### BRIEF DESCRIPTION OF THE DRAWINGS

FIG. 1 is a block diagram showing the arrangement of a printer in one embodiment according to the present invention;

FIG. 2 is a block diagram showing the arrangement of a printer control unit arranged in the printer in this embodiment;

FIG. 3 illustrates the concept of color processing using an attribute information storage area;

FIG. 4 illustrates an example in which information stored in a conventional attribute information storage area becomes inappropriate;

FIGS. 5A and 5B illustrate an example in which information stored in a conventional attribute information storage area becomes inappropriate;

FIGS. 6A and 6B illustrate an example in which information stored in an attribute information storage area in this embodiment becomes appropriate;

FIG. 7 is a flowchart showing the drawing logic determination processing of a first drawing object which configures transparent processing in this embodiment;

FIG. 8 is a flowchart showing the drawing logic determination processing of a second drawing object which configures the transparent processing in this embodiment;

FIG. 9 is a flowchart showing the drawing logic determination processing of a third drawing object which configures the transparent processing in this embodiment;

FIG. 10 is a flowchart showing the drawing logic change processing of the first to third drawing objects, which configure the transparent processing in this embodiment;

FIG. 11 is a flowchart showing the update processing of the attribute information storage area by drawing attributes of drawing objects upon drawing of this embodiment;

FIG. 12 is a flowchart showing the composition processing of first to third drawing objects, which configure transparent processing in a second embodiment; and

FIG. 13 is a view showing the concept of general drawing processing based on a painters model.

### DESCRIPTION OF THE EMBODIMENTS

The present invention will be described in detail hereinafter based on exemplary embodiments with reference to the accompanying drawings. Note that the arrangements described in the following embodiments are merely examples, and the present invention is not limited to the illustrated arrangements.

### Apparatus Arrangement

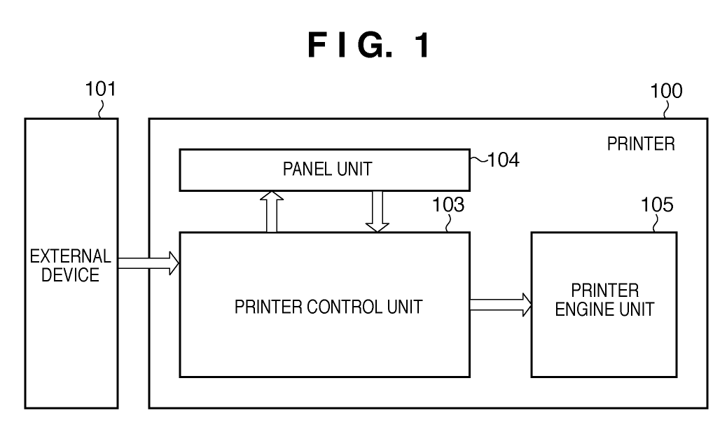

FIG. 1 is a block diagram showing the arrangement of a printer as a printing device in this embodiment. As shown in FIG. 1, a printer 100 of this embodiment includes a printer control unit 103, a printer engine unit 105, and a panel unit 104.

The printer control unit 103 receives code data (ESC codes, various page description languages (PDL), and the like) from an external device 101 such as a host computer or the like, and generates image data (page information) by interpreting the code data. The generated image data is transmitted to the printer engine unit 105 via an interface (not shown).

The printer engine unit 105 forms an image represented by the image data generated by the printer control unit 103 on a paper sheet by an electrophotographic process. The printer engine unit 105 includes mechanisms mechanically associated with image formation, and an engine controller which executes control associated with print processing (e.g., paper feed processing and the like) by these mechanisms. The panel unit 104 configures an operation unit which controls a user interface, with which the user makes input operations for instructing the printer 100 to execute desired operations.

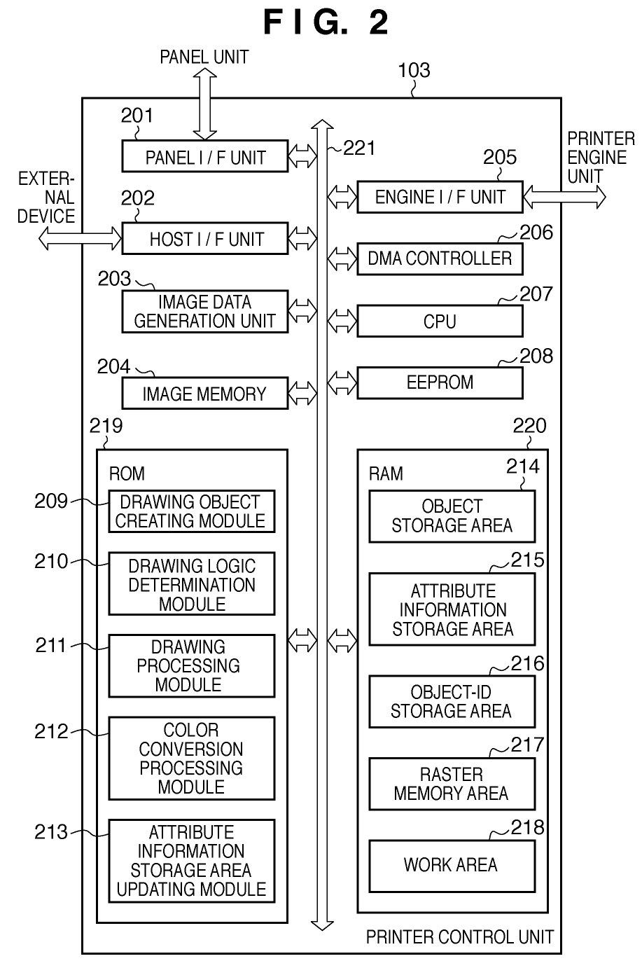

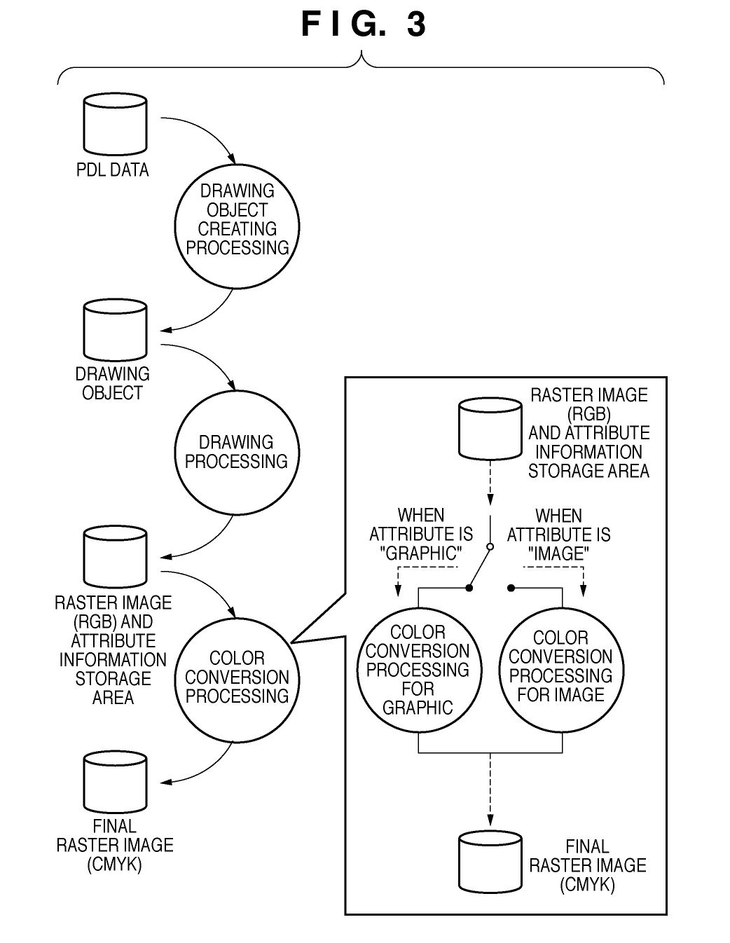

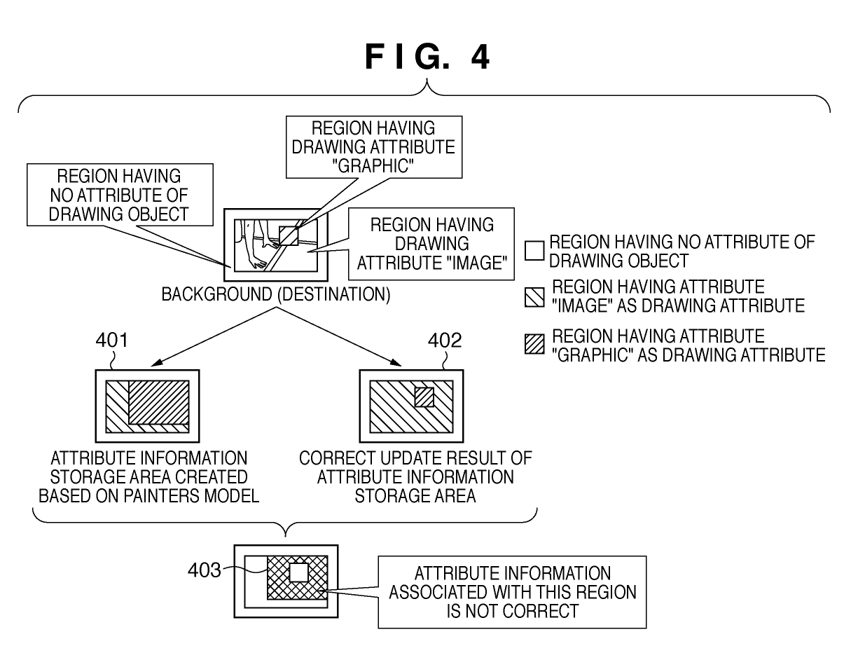

The arrangement of the printer control unit 103 will be described below with reference to FIG. 2. The printer control unit 103 configures an input/output unit of signals exchanged between a CPU 207 which controls the overall printer control unit 103, and the external device 101. The printer control unit 103 also includes a host I/F unit 202 which executes communication control with the external device 101. The host I/F unit 202 includes an input buffer which inputs print data output from the external device 101, and an output buffer which temporarily holds a signal to be output to the external device 101.

The code data input via the host I/F unit 202 is supplied to an image data generation unit 203. The image data generation unit 203 creates bitmap data (image data) that the printer engine unit 105 can process based on the input code data. The created bitmap data is stored in an image memory 204.

The CPU 207 controls a drawing object creating module 209 to create a drawing object in accordance with control codes stored in a ROM 219, and controls a drawing logic determination module 210 to determine specific drawing logic. The CPU 207 then registers the drawing object in an object storage area 214 in a RAM 220. The CPU 207 controls a drawing processing module 211 to draw the drawing object registered in the object storage area 214 to generate a raster image, and controls an attribute information storage area updating module 213 to update information of an attribute information storage area 215. The CPU 207 controls a color conversion processing module 212 to convert the display color of the generated raster image from RGB to CMYK based on the information in the attribute information storage area 215 in accordance with control codes stored in the ROM 219.

As described above, the drawing object created by the drawing object creating module 209 is stored in the object storage area 214 allocated in the RAM 220. The RAM 220 includes the attribute information storage area 215, an object-ID storage area 216, a raster memory area 217, and a work area 218.

The attribute information storage area 215 stores attribute information for each pixel, which is required to optimally apply the aforementioned color processing. The object-ID storage area 216 stores an ID (identification information) of an object to be drawn. An area required to render an object stored in the object storage area 214 is allocated in the raster memory area 217. An area used by the CPU 207 for other work is allocated in the work area 218.

Reading of the bitmap data stored in the image memory 204 is controlled by a DMA controller 206. The control by this DMA controller 206 is done based on an instruction from the CPU 207.

The bitmap data read out from the image memory 204 is transferred to the printer engine unit 105 as a video signal via an engine I/F unit 205. The engine I/F unit 205 includes an output buffer, which temporarily holds the video signal to be transferred to the printer engine unit 105, and an input buffer (not shown), which temporarily holds a signal output from the printer engine unit 105. That is, the engine I/F unit 205 configures an input/output unit of signals exchanged between the printer engine unit 105 and printer control unit 103, and executes communication control with the printer engine unit 105.

Instructions associated with mode settings based on operation inputs from the panel unit 104 are input via a panel I/F unit 201. The panel I/F unit 201 configures an interface between the panel unit 104 and CPU 207.

The CPU 207 controls the above-described blocks in FIG. 2 in accordance with a mode designated from the panel unit 104. This control is executed based on control programs stored in the ROM 219. Note that the control programs include the drawing object creating module 209, drawing logic determination module 210, drawing processing module 211, color conversion processing module 212, and attribute information storage area updating module 213. These control programs stored in the ROM 219 include an OS which executes time-divisional control for respective load modules called tasks based on system clocks, and a plurality of load modules, execution of which is controlled for respective functions by this OS. The control programs including these load modules are stored in an EEPROM (nonvolatile memory) 208 as needed.

The above-described blocks including the CPU 207 are connected to a system bus 221 to allow the CPU 207 to access the respective blocks. The system bus 221 includes an address bus and system bus.

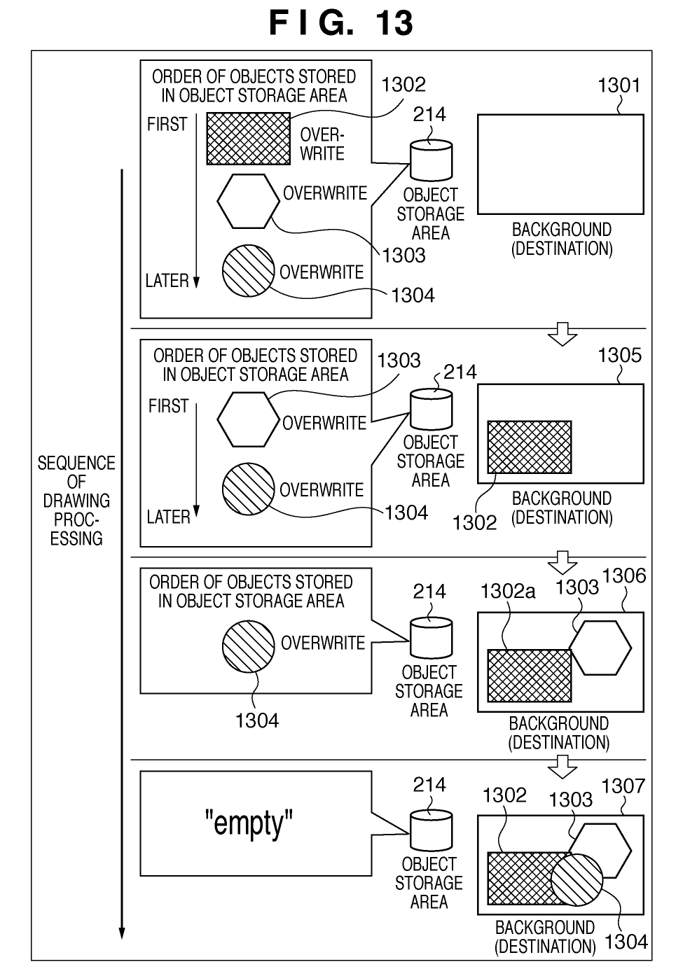

The drawing processing module 211 executes drawing using a configuration based on the painters model. The painters model will be described below with reference to FIG. 13.

In the object storage area 214, drawing objects, which are created by the drawing object creating module 209 after completion of PDL interpretation, are registered in the order of drawing. As shown in FIG. 13, assume that drawing objects 1302, 1303, and 1304 are registered in the object storage area 214 upon completion of registration of all drawing objects. In this case, the painters model executes drawing processing as follows. The drawing object 1302 is drawn on a background (as a destination) 1301 to create a next background 1305. The drawing object 1303 is then drawn on the background 1305 to create a next background 1306. Finally, the drawing object 1304 is drawn on the background 1306 to create a background 1307.

As described above, according to the painters model, overwrite drawing of the drawing objects is executed in accordance with the order of drawing registered in the object storage area 214. That is, according to the painters model, which object is located on the top face is not determined for respective pixels before drawing.

### Object Storage Processing (Example of Transparent Processing)

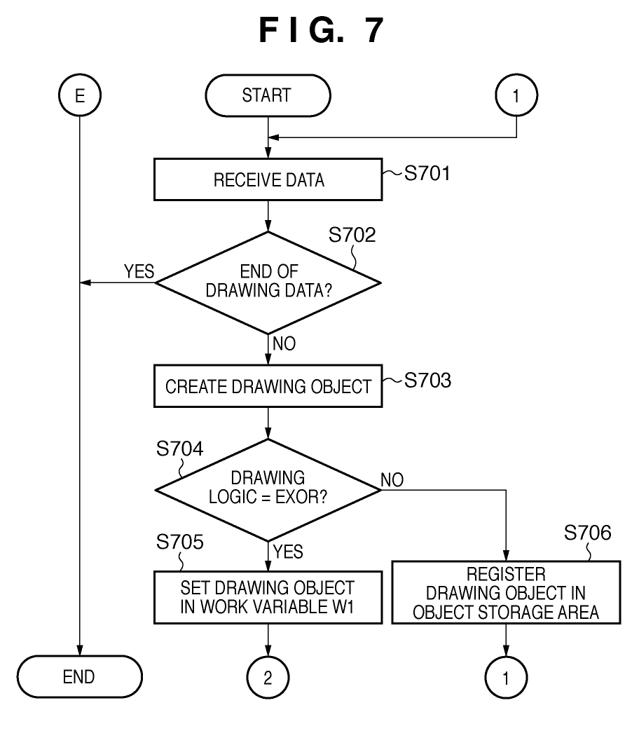

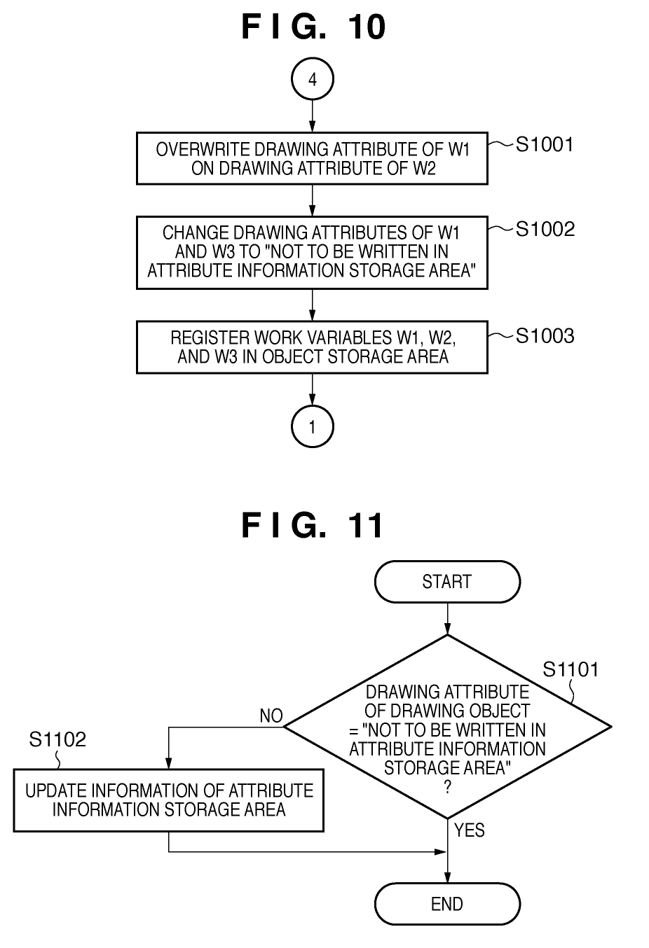

Object storage processing with respect to the object storage area 214 in the printer control unit 103 of this embodiment will be described below with reference to the flowcharts of FIGS. 7 to 10. In this embodiment, transparent processing including a plurality of drawing logic is determined by the processes in FIGS. 7 to 9, and drawing objects which configure the transparent processing are stored in the object storage area 214 while their drawing attributes are updated by the process in FIG. 10.

The processes shown in the flowcharts of FIGS. 7 to 9 extract transparent processing (transparent object group) including drawing objects of three types “EXOR”, “overwrite”, and “EXOR”.

First determination processing for determining whether or not a first drawing object has an EXOR drawing logic will be described first with reference to FIG. 7. In step S701, the CPU 207 receives data from the external device 101 via the host I/F unit 202, and interprets the data (e.g., PDL interpretation). In step S702, as a result of interpretation of the data, the CPU 207 determines whether the end of the data has been detected. If it is determined that the end of the data has been detected (YES in step S702), this determination processing ends. If it is determined that the end of the data has not been detected (NO in step S702), the process advances to step S703. In step S703, the CPU 207 converts the received data into a drawing object (intermediate data that the drawing processing module 211 can handle) based on the interpretation result in step S701 according to the drawing object creating module 209. At this time, the drawing object includes its drawing attribute.

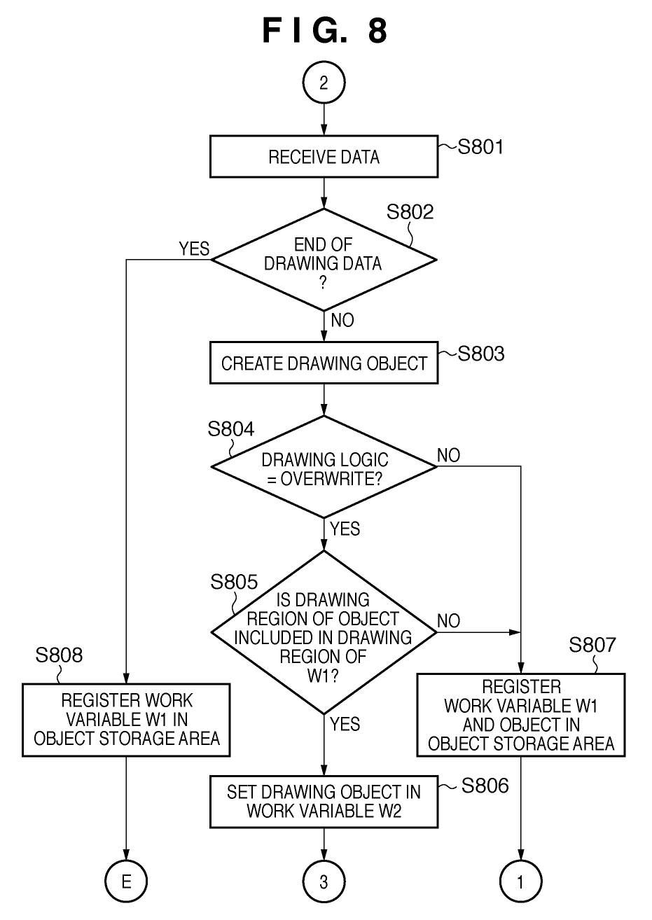

The CPU 207 determines in step S704 according to the drawing logic determination module 210 if the drawing object has an EXOR drawing logic. If it is determined that the drawing object does not have an EXOR drawing logic (NO in step S704), the CPU 207 registers the drawing object in the object storage area 214 in step S706, and the process returns to step S701. On the other hand, if the drawing object has an EXOR drawing logic (YES in step S704), the CPU 207 sets the drawing object in a work variable W1 as a first drawing object in step S705, and the process advances to step S801 in FIG. 8.

Second determination processing for determining whether or not a second drawing object has overwrite drawing logic will be described below with reference to FIG. 8. In step S801, the CPU 207 receives data from the external device 101 via the host I/F unit 202, and interprets the data. In step S802, as a result of interpretation of the data, the CPU 207 determines whether the end of the data has been detected. If it is determined that the end of the data has been detected (YES in step S802), the process advances to step S808 to store the work variable W1 in the object storage area 214 and this determination processing ends. If the CPU 207 determines that the end of the data was not detected (NO in step S802), the process advances to step S803. In step S803, the CPU 207 converts the received data into a drawing object (intermediate data that the drawing processing module 211 can handle) based on the interpretation result in step S801 according to the drawing object creating module 209. At this time, the drawing object includes information of its drawing attribute.

The CPU 207 determines in step S804 according to the drawing logic determination module 210 if the drawing object has overwrite drawing logic. If it is determined that the drawing object does not have an overwrite drawing logic (NO in step S804), the CPU 207 registers the work variable W1 and the drawing object in the object storage area 214 in step S807, and the process returns to step S701. On the other hand, if the drawing object has overwrite drawing logic (YES in step S804), the CPU 207 advances the process to step S805.

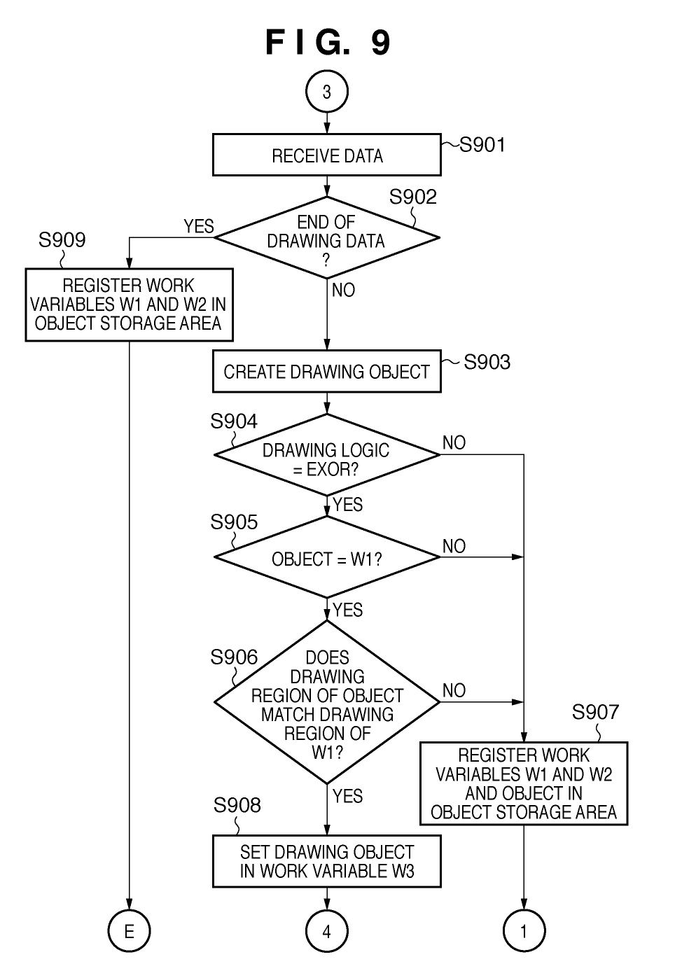

The CPU 207 determines in step S805 according to the drawing logic determination module 210 if a drawing region of the drawing object is included in that of the work variable W1. If it is determined that the drawing region of the drawing object is not included in that of the work variable W1 (NO in step S805), the process advances to step S807, and the CPU 207 registers the work variable W1 and the drawing object in the object storage area 214. After that, the process returns to step S701. On the other hand, if it is determined that the drawing region of the drawing object is included in that of the work variable W1 (YES in step S805), the CPU 207 advances the process to step S806. In step S806, the CPU 207 sets the drawing object in a work variable W2 as a second drawing object, and the process advances to step S901 in FIG. 9.

Third determination processing for determining whether or not a third drawing object has an EXOR drawing logic will be described below with reference to FIG. 9. In step S901, the CPU 207 receives data from the external device 101 via the host I/F unit 202, and interprets the data. In step S902, as a result of interpretation of the data, the CPU 207 determines whether the end of the data has been detected. If it is determined that the end of the data has been detected (YES in step S902), the process advances to step S909 to store the work variables W1 and W2 in the object storage area 214 and this determination processing ends. On the other hand, if it is determined that the CPU 207 did not detect the end of the data (NO in step S902), the process advances to step S903. In step S903, the CPU 207 converts the received data into a drawing object based on the interpretation result in step S901 according to the drawing object creating module 209. At this time, the drawing object includes information of its drawing attribute.

The CPU 207 determines in step S904 according to the drawing logic determination module 210 if the drawing object has an EXOR drawing logic. If it is determined that the drawing object does not have an EXOR drawing logic (NO in step S904), the CPU 207 registers the work variables W1 and W2, and the drawing object in the object storage area 214 in step S907, and the process returns to step S701. On the other hand, if it is determined that the drawing object has an EXOR drawing logic (YES in step S904), the CPU 207 advances the process to step S905.

The CPU 207 determines in step S905 according to the drawing logic determination module 210 whether or not the drawing object is identical to the first drawing object set in the work variable W1, that is, whether or not the drawing object has the same shape, color information, and drawing position as those of the first drawing object. If it is determined that the drawing object is not identical to the first drawing object (NO in step S905), the process advances to step S907, and the CPU 207 registers the work variables W1 and W2, and the drawing object in the object storage area 214. After that, the process returns to step S701. On the other hand, if it is determined that the object is identical to the first drawing object set in the work variable W1 (YES in step S905), the CPU 207 advances the process to step S906.

The CPU 207 determines in step S906 whether or not a drawing region of the object matches that of the first drawing object set in the work variable W1, that is, whether or not the object has the same drawing position as that of the first drawing object. If it is determined that the two drawing regions do not match (NO in step S906), the CPU 207 registers the work variables W1 and W2, and the drawing object in the object storage area 214 in step S907, and the process returns to step S701. On the other hand, if it is determined that the drawing region of the object matches that of the first drawing object set in the work variable W1 (YES in step S906), the CPU 207 advances the process to step S908. In step S908, the CPU 207 sets the drawing object in a work variable W3 as a third drawing object, and the process advances to step S1001 in FIG. 10.

With the aforementioned first to third determination processes shown in FIGS. 7 to 9, the transparent processing (transparent object group) including drawing objects (first to third drawing objects) of three types “EXOR”, “overwrite”, and “EXOR” is extracted, and the process advances to step S1001 in FIG. 10. Note that objects other than this transparent processing are stored in turn in the object storage area 214.

Processing for updating the drawing attributes of the respective objects with respect to the transparent object group, which is determined by the processes shown in FIGS. 7 to 9, and includes the drawing objects of three types “EXOR”, “overwrite”, and “EXOR”, will be described below with reference to FIG. 10. With this update processing, the attribute information storage area 215 can be appropriately updated.

Note that the drawing objects (first to third drawing objects) of three types “EXOR”, “overwrite”, and “EXOR”, which configure the transparent processing, are respectively stored in the work variables W1, W2, and W3. In step S1001, a drawing attribute recorded in the drawing object set in the work variable W1 or W3 is overwritten on that of the work variable W2. This is because in the transparent processing including EXOR—overwrite—EXOR, the drawing region follows the central drawing object, but the object to be actually drawn is the first or last drawing object. That is, as the drawing attribute, the first or last attribute needs to be reflected.

In step S1002, the drawing attributes of the work variables W1 and W3 are changed to “not to be written in attribute information storage area” attributes. In step S1003, the work variables W1, W2, and W3 are registered in the object storage area 214, and the process then returns to step S701 in FIG. 7.

With the above processing, the drawing objects of three types, which configure the transparent processing, are stored in the object storage area 214 after their drawing attributes are updated.

### Update Processing of Attribute Information Storage Area (Example of Transparent Processing)

In this embodiment, upon drawing a plurality of drawing objects registered in the object storage area 214 by the aforementioned processes described using FIGS. 7 to 10 by the drawing processing module 211, the raster memory area 217 and attribute information storage area 215 are updated as needed.

FIG. 11 is a flowchart showing the update processing of the attribute information storage area 215 in this embodiment. The CPU 207 determines in step S1101 according to the drawing processing module 211 whether or not the drawing attribute of the drawing object is a “not to be written in attribute information storage area” attribute. Such attribute is set for the first and third drawing objects that configure the transparent processing in step S1002 in FIG. 10 described above. If the drawing attribute of the drawing object is a “not to be written in attribute information storage area” attribute (YES in step S1101), the CPU 207 ends the processing without updating the attribute information storage area 215. However, if the drawing attribute of the drawing object is not a “not to be written in attribute information storage area” attribute (NO in step S1101), the CPU 207 overwrites the drawing attribute of that drawing object on the corresponding drawing object storage area of the attribute information storage area 215 according to the attribute information storage area updating module 213 in step S1102. Then the CPU 207 ends the processing.

As described above, by determining the “not to be written in attribute information storage area” attribute, the contents of the attribute information storage area 215 can be updated to appropriately implement the transparent processing.

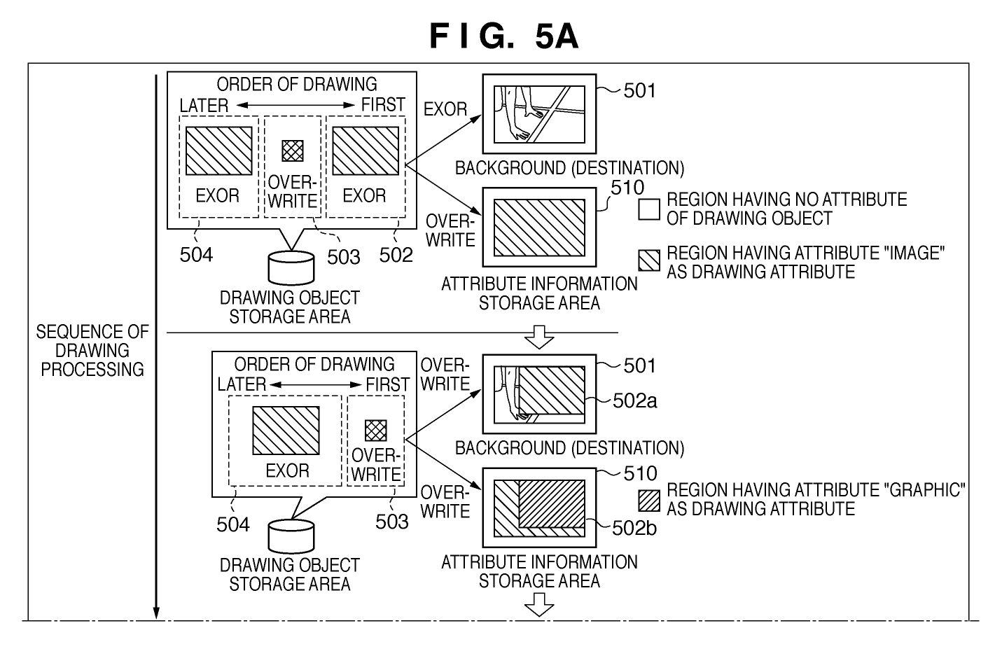

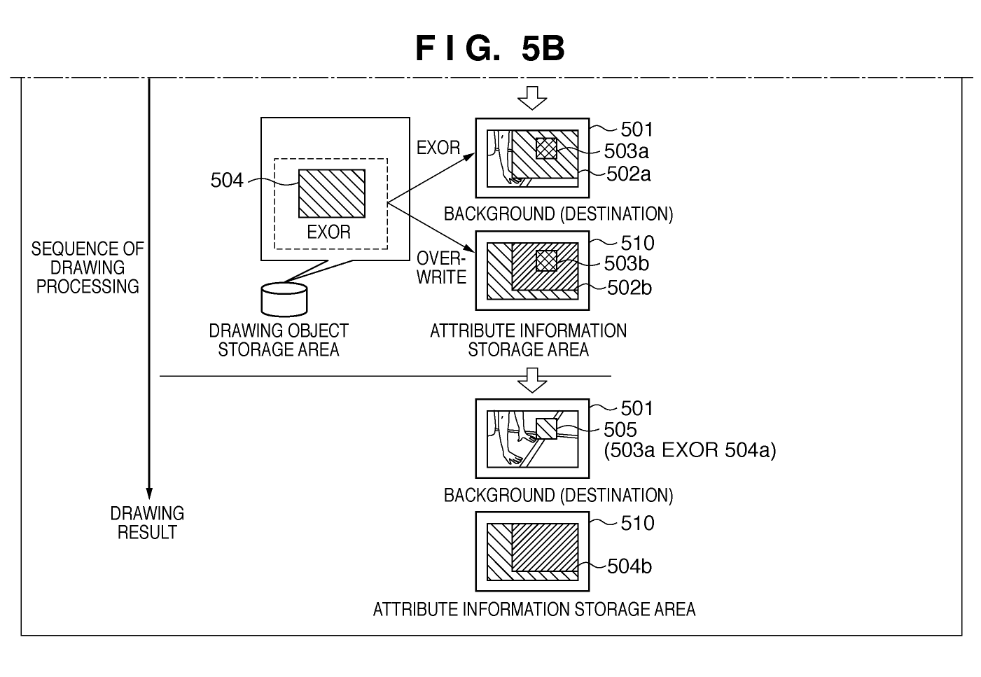

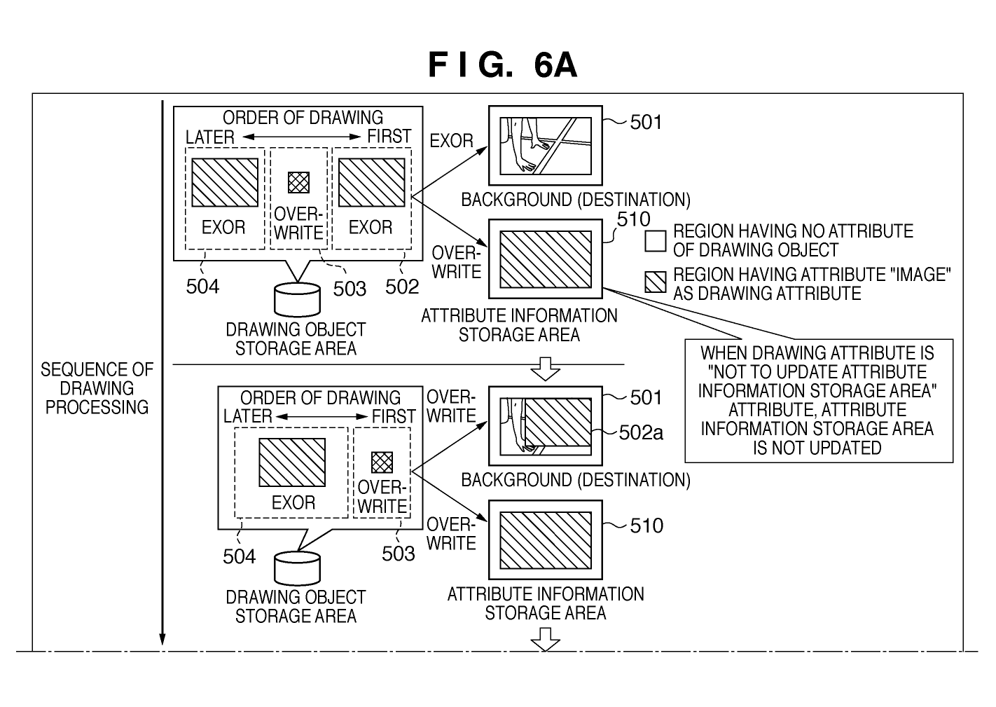

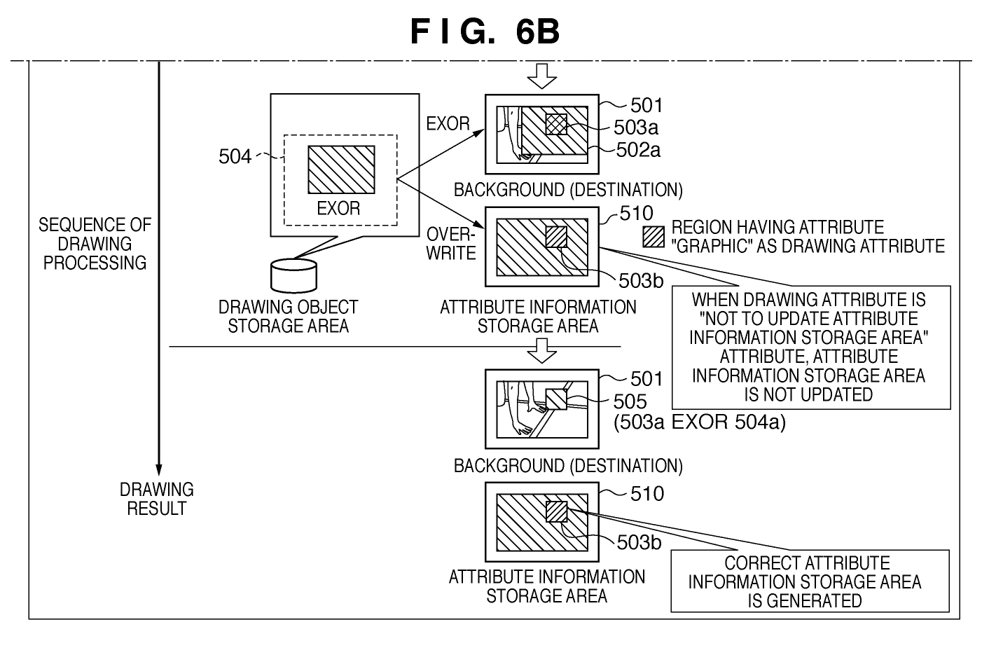

FIGS. 6A and 6B show an example in which the attribute information storage area 215 is appropriately updated in this embodiment. The same reference numerals in FIGS. 6A and 6B denote the same components as in FIGS. 5A and 5B to allow easy comparison with FIGS. 5A and 5B above. That is, FIGS. 6A and 6B show a state in which a drawing object 502 having an EXOR drawing logic, a black drawing object 503 having an overwrite (or transparent) drawing logic, and a drawing object 504 having an EXOR drawing logic are sequentially overlaid and drawn on a background 501. Note that the objects 502 and 504 are the same drawing objects. For the sake of simplicity, the drawing objects 502, 503, and 504 will be respectively referred to as first, second, and third drawing objects hereinafter.

In FIGS. 6A and 6B, as shown in the upper stage of FIG. 6A, the first drawing object 502 is overlaid on the background 501, all pixels of which have a drawing attribute “image”, by performing EXOR, and is stored in the raster memory area 217. However, the attribute information storage area 215 is not overwritten since the drawing attribute of the first drawing object 502 is a “not to be written in attribute information storage area” attribute. As a result, as shown in the lower stage of FIG. 6A, a region 502a of the background 501 is updated in correspondence with the drawing object 502, but the attribute information storage area 215 is not updated.

Next, the black second drawing object 503 is overlaid by overwriting. As shown in the upper stage of FIG. 6B, regions 503a and 503b of the background 501 and attribute information storage area 215 are updated by overwriting in correspondence with the second drawing object 503. At this time, the drawing attribute of the second drawing object 503 is overwritten in advance by that (graphic) of the drawing object 502 or 504.

Finally, the third drawing object 504 is overlaid by performing EXOR. In this way, the first to third drawing objects 502 to 504 are drawn in turn. As a result, as shown in the lower stage of FIG. 6B, a drawing result 505 equivalent to processing for setting the first drawing object 502 (or third drawing object 504) to be transparent in the shape of the second drawing object 503 with respect to the background 501 can be obtained on the raster memory area 217 as a final drawing result. At this time, as for the attribute information storage area 215, since the drawing attribute of the last third drawing object 504 is a “not to be written in attribute information storage area” attribute with respect to the shape of the second drawing object 503, no drawing region is overwritten. Therefore, the attribute information storage area 215 can store appropriate attribute information indicating the region 503b to have the shape according to the overlaid drawing objects as the transparent processing in the raster memory area 217.

As described above, according to this embodiment, an image processing method, which sequentially updates bitmap data and attribute information for respective pixels of the bitmap data by sequentially rendering a plurality of drawing objects respectively having drawing attributes, has the following characteristic function. That is, this embodiment is characterized in that a transparent object group which expresses transparent processing by a plurality of drawing objects is detected, and the drawing attribute of a predetermined drawing object in the detected transparent object group is updated to an attribute indicating that the attribute information is not updated.

Therefore, even upon execution of transparent processing including a plurality of drawing logic, the drawing processing can be done as in the example shown in FIGS. 6A and 6B, and the attribute information storage area 215 can be updated by appropriate attribute information. Hence, even a renderer, the drawing algorithm of which is based on the painters model, can obtain an optimal output result.

In the above-described example of this embodiment, the drawing attribute of a specific drawing object is changed to a “not to be written in attribute information storage area” attribute. However, as for a drawing object whose drawing attribute should not be used to update the attribute information storage area 215, that updating need only be controlled to be inhibited. For example, for a drawing object whose drawing attribute should not be used to update the attribute information storage area 215, an attribute information update inhibition flag may be set, and update control can be made based on that flag upon actual drawing.

A second embodiment according to the present invention will be described hereinafter. Since the apparatus arrangement in the second embodiment is the same as the above-described first embodiment, a repetitive description thereof will not be provided.

In the second embodiment as well, transparent processing including a plurality of drawing logic is determined, and the drawing attributes of drawing objects which configure the transparent processing are updated, thus allowing appropriately updating the attribute information storage area 215, as in the above-described first embodiment. In the second embodiment, the update method of the drawing attributes of drawing objects that configure the transparent processing is different from the first embodiment.

### Object Storage Processing

Object storage processing with respect to the object storage area 214 in the printer control unit 103 of the second embodiment will be described below. In the second embodiment as well, a transparent object group including drawing objects of three types “EXOR”, “overwrite”, and “EXOR” is extracted by the processes shown in the flowcharts of FIGS. 7 to 9 as in the above-described first embodiment. A description of these processes will not be repeated.

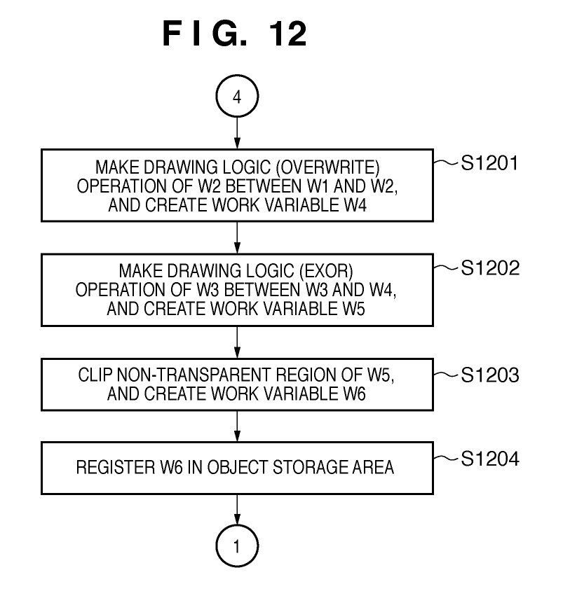

Furthermore, by the process shown in the flowchart of FIG. 12, the respective drawing objects of the transparent object group are stored in the object storage area 214 by updating their attribute information.

In step S1201, a drawing logic operation (“overwrite” in this case) of the work variable W2 is made between the work variables W1 and W2, and a created drawing object is set in a work variable W4 as a fourth drawing object. In step S1202, a drawing logic operation (“EXOR” in this case) of the work variable W3 is made between the work variables W3 and W4, and a created drawing object is set in a work variable W5 as a fifth drawing object. In the fifth drawing object set in the work variable W5, the shape of the drawing object of the work variable W2 consequently remains as a non-transparent region.

In step S1203, the non-transparent region (corresponding to the work variable W2) is clipped from the work variable W5 by clipping processing, and the clipped region is set in a work variable W6 as a sixth drawing object. In step S1204, the drawing attribute of the sixth drawing object set in the work variable W6 is registered in the object storage area 214 as that of the work variable W1 or W3, and the process then returns to step S701 in FIG. 7.

With the above-described processing, one drawing object obtained by composing the drawing objects of three types that configure the transparent object group is stored in the object storage area 214 as a composite object, after its drawing attribute is appropriately updated.

Note that the update processing of the attribute information storage area 215 in the second embodiment does not require any special processing since one composite object finally stored in the object storage area 214 need only be drawn.

As described above, according to the second embodiment, even upon execution of transparent processing including a plurality of drawing logic, a composite object obtained by composing the plurality of drawing objects is created. As a result, the attribute of an object to be actually drawn can be prevented from being different from that stored in the attribute information storage area, and even a renderer, the drawing algorithm of which is based on the painters model, can obtain an optimal output result.

In the example of this embodiment, the transparent processing as a combination of drawing logic EXOR-overwrite-EXOR with respect to the background is detected. A drawing pattern to be detected by the present invention is not limited to such a specific example. For example, the present invention can be similarly applied to transparent processes implemented by combinations EXOR-AND-EXOR, AND-OR, and the like.

The present invention can adopt embodiments in the forms of, for example, a system, apparatus, method, program, storage medium (recording medium), and the like. More specifically, the present invention can be applied to either a system including a plurality of devices (e.g., a host computer, interface device, image sensing device, web application, and the like), or an apparatus consisting of a single device.

The present invention can also be achieved by directly or remotely supplying a program (software) that implements the functions of the above-described embodiments to a system or apparatus, and reading out and executing the supplied program code by a computer of that system or apparatus. Note that the program in this case is a computer-readable program corresponding to each illustrated flowchart in the embodiments.

Therefore, the program code itself installed in a computer to implement the functional processing of the present invention using the computer implements the present invention.

In this case, the form of program is not particularly limited, and object code, a program to be executed by an interpreter, script data to be supplied to an OS, and the like may be used as long as they have the functions of the program.

As a recording medium for supplying the program, the following media can be used. For example, a floppy disk, hard disk, optical disk, magneto-optical disk (MO), CD-ROM, CD-R, CD-RW, magnetic tape, nonvolatile memory card, ROM, DVD (DVD-ROM, DVD-R), and the like can be used.

As a program supply method, the following method may be used. That is, the user establishes a connection to a homepage on the Internet using a browser on a client computer, and downloads the computer program itself of the present invention (or a compressed file including an automatic installation function) from the homepage onto a recording medium such as a hard disk or the like. Also, the program code that forms the program of the present invention may be segmented into a plurality of files, which may be downloaded from different homepages.

Also, a storage medium such as a CD-ROM or the like, which stores the encrypted program of the present invention, may be delivered to the user, and the user who has cleared a predetermined condition may be allowed to download key information used to decrypt the encrypted program from a homepage via the Internet. That is, the user executes the encrypted program using that key information to install the program on a computer.

The functions of the above-described embodiments can be implemented when the computer executes the readout program. Furthermore, the functions of the above-described embodiments can be implemented when an OS or the like running on the computer executes some or all of actual processing operations based on an instruction of that program.

Furthermore, the functions of the above-described embodiments can be implemented when the program read out from the recording medium is written in a memory equipped on a function expansion board or a function expansion unit, which is inserted into or connected to the computer, and is then executed. Therefore, a CPU equipped on the function expansion board or unit can execute some or all of actual processing operations based on an instruction of that program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-337661, filed Dec. 27, 2007, which is hereby incorporated by reference herein in its entirety.

What is claimed is:

1. An image processing method of creating bitmap data based on a plurality of drawing objects by sequentially rendering the plurality of drawing objects respectively having drawing attributes and drawing logic, and sequentially updating the bitmap data and attribute information for each pixel of the bitmap data, the image processing method comprising:
detecting a transparent object group, which expresses transparent processing and includes a plurality of drawing objects, based on the drawing logic; and
updating a drawing attribute of a predetermined drawing object of the plurality of drawing objects in the detected transparent object group to an attribute indicating that the attribute information of the bitmap data is not updated.

2. The image processing method according to claim 1, wherein the transparent object group includes a first drawing object of which the drawing logic is an exclusive OR, a second drawing object of which the drawing logic is an overwrite, and a third drawing object of which the drawing logic is an exclusive OR.

3. The image processing method according to claim 2, wherein the detecting step comprises:
a first determination step of determining, when drawing logic of a drawing object is an exclusive OR, that the drawing object is the first drawing object;
a second determination step of determining, when drawing logic of a drawing object next to the first drawing object is an overwrite and the drawing object next to the first drawing object is drawn within a drawing region of the first drawing object, that the drawing object next to the first drawing object is the second drawing object; and
a third determination step of determining, when drawing logic of a drawing object next to the second drawing object is an exclusive OR and the drawing object next to the second drawing object has the same shape, color information and drawing position as the first drawing object, that the drawing object next to the second drawing object is the third drawing object.

4. The image processing method according to claim 2, wherein in the updating step,
the drawing attribute of the first or third drawing object is overwritten on the drawing attribute of the second drawing object, and
the attribute indicating that the attribute information is not updated is set in the drawing attributes of the first and third drawing objects.

5. The image processing method according to claim 1, wherein the transparent object group includes a first drawing object of which the drawing logic is an exclusive OR, a second drawing object of which the drawing logic is a logical product, and a third drawing object of which the drawing logic is an exclusive OR.

6. The image processing method according to claim 1, wherein the transparent object group includes a first drawing object of which the drawing logic is a logical product, and a second drawing object of which the drawing logic is a logical sum.

7. The image processing method according to claim 1, wherein the drawing attribute of the drawing object indicates a type of the drawing object.

8. A computer-readable recording medium recording a program for making a computer execute an image processing method according to claim 1.

9. An image processing method of creating bitmap data based on a plurality of drawing objects by sequentially rendering the plurality of drawing objects respectively having drawing attributes and drawing logic, and sequentially updating the bitmap data and attribute information for each pixel of the bitmap data, the image processing method comprising:
detecting a transparent object group, which expresses transparent processing and includes a plurality of drawing objects, based on the drawing logic; and
generating a composite object by composing the drawing objects which configure the detected transparent object group in correspondence with the drawing logic,
wherein the composite object is used in place of the transparent object group upon drawing.

10. The image processing method according to claim 9, wherein the transparent object group includes a first drawing object of which the drawing logic is an exclusive OR, a second drawing object of which the drawing logic is an overwrite, and a third drawing object of which the drawing logic is an exclusive OR.

11. The image processing method according to claim 10, wherein the detecting step comprises:
a first determination step of determining, when drawing logic of a drawing object is an exclusive OR, that the drawing object is the first drawing object;
a second determination step of determining, when drawing logic of a drawing object next to the first drawing object is an overwrite and the drawing object next to the first drawing object is drawn within a drawing region of the first drawing object, that the drawing object next to the first drawing object is the second drawing object; and
a third determination step of determining, when drawing logic of a drawing object next to the second drawing object is an exclusive OR and the drawing object next to the second drawing object has the same shape, color information and drawing position as the first drawing object, that the drawing object next to the second drawing object is the third drawing object.

12. The image processing method according to claim 10, wherein in the generating the composite object step,
a fourth drawing object is created by making an overwrite operation of the second drawing object on the first drawing object,
a fifth drawing object having a non-transparent region is created by making an exclusive OR operation between the third drawing object and the fourth drawing object,
a sixth drawing object is created by extracting the non-transparent region in the fifth drawing object, and
the composite object is created to have the drawing attribute of the sixth drawing object as the drawing object of the first or third drawing object.

13. The image processing method according to claim 9, wherein the transparent object group includes a first drawing object of which the drawing logic is an exclusive OR, a second drawing object of which the drawing logic is a logical product, and a third drawing object of which the drawing logic is an exclusive OR.

14. The image processing method according to claim 9, wherein the transparent object group includes a first drawing object of which the drawing logic is a logical product, and a second drawing object of which the drawing logic is a logical sum.

15. The image processing method according to claim 9, wherein the drawing attribute of the drawing object indicates a type of the drawing object.

16. A computer-readable recording medium recording a program for making a computer execute an image processing method according to claim 9.

17. An image processing apparatus for creating bitmap data based on a plurality of drawing objects by sequentially rendering the plurality of drawing objects respectively having drawing attributes and drawing logic, and sequentially updating the bitmap data and attribute information for each pixel of the bitmap data, the image processing apparatus comprising:
a detection unit adapted to detect a transparent object group, which expresses transparent processing and includes a plurality of drawing objects, based on the drawing logic; and
an updating unit adapted to update a drawing attribute of a predetermined drawing object of the plurality of drawing objects in the detected transparent object group to an attribute indicating that the attribute information of the bitmap data is not updated.

18. An image processing apparatus for creating bitmap data based on a plurality of drawing objects by sequentially rendering the plurality of drawing objects respectively having drawing attributes and drawing logic, and sequentially updating the bitmap data and attribute information for each pixel of the bitmap data, the image processing apparatus comprising:
a detection unit adapted to detect a transparent object group, which expresses transparent processing and includes a plurality of drawing objects, based on the drawing logic; and
a composing unit adapted to generate a composite object by composing the drawing objects which configure the detected transparent object group in correspondence with the drawing logic,
wherein the composite object is used in place of the transparent object group upon drawing.
